(19) United States
(12) Patent Application Publication
(10) Pub. No.: US 2012/0247753 A1
(43) Pub. Date: Oct. 4, 2012

(54) HYBRID MOTOR VEHICLE HAVING TWO COOLING CIRCUITS

(75) Inventor: Max Bachmann, Friedrichshafen (DE)

(73) Assignee: ZF FRIEDRICHSHAFEN AG, Friedrichshafen (DE)

(21) Appl. No.: 13/515,383

(22) PCT Filed: Nov. 22, 2010
(86) PCT No.: PCT/EP10/67888

§ 371 Date: Jun. 12, 2012

(30) Foreign Application Priority Data
Dec. 17, 2009 (DE) 10 2009 054 873.4

(51) Int. Cl. G05D 23/00

(52) U.S. Cl. 165/287; 180/65.25; 903/904

(57) ABSTRACT

A motor vehicle having a hybrid drive and a transmission which is connected between the hybrid drive and an output drive. The hybrid drive comprises an internal combustion engine, an electric machine, an electric energy store and power electronics. The motor vehicle has a high temperature cooling circuit which includes a first radiator, for cooling the internal combustion engine of the hybrid drive, and a first low temperature cooling circuit, which comprises a second radiator, and a second low temperature cooling circuit which comprises a cooling system. The energy store of the hybrid drive and the power electronics of the hybrid drive are cooled, in a temperature-dependent manner, by way of the second radiator and thus by the first low temperature cooling circuit, or by way of the cooling system and thus by the second low temperature cooling circuit.

This application is a National Stage completion of PCT/EP2010/067888 filed Nov. 22, 2010, which claims priority from German patent application serial no. 10 2009 054 873.4 filed Dec. 17, 2009.

### FIELD OF THE INVENTION

The invention relates to a motor vehicle comprising at least a transmission and a hybrid drive.

### BACKGROUND OF THE INVENTION

The main components of a drive train of a motor vehicle are a drive assembly and a transmission. A transmission converts torques and rotational speeds, and in this way transforms the tractive force provided by the drive assembly. The present invention relates to a motor vehicle, the drive train thereof comprising at least a transmission and a hybrid drive, having an internal combustion engine and an electric machine, as a drive assembly.

FIG. 1 shows a very schematic block diagram of a motor vehicle having a hybrid drive, comprising an internal combustion engine 1 and an electric machine 2, having a transmission 3 and having an output drive 4, where in the example of FIG. 1, a clutch 5 is connected between the internal combustion engine 1 and the electric machine 2 of the hybrid drive. During purely electric-motor travel, the clutch 5 is disengaged, and the internal combustion engine 1 is decoupled from the output drive 4. During hybrid travel, the clutch 5 is engaged, and the internal combustion engine 1 is coupled to the output drive 4. This structure is also called a parallel hybrid.

According to FIG. 1, an electric energy store 6 is assigned to the electric machine 2 of the hybrid drive. When the electric machine 2 is operated as a generator, the electric energy store 6 can be charged using the electric machine 2. In contrast, when the electric machine 2 is operated as a motor, the energy stored in the electric energy store 6 is used to drive the electric machine 2. Power electronics 7 are used to control the electric energy store 6 and/or the electric machine 2.

The internal combustion engine 1 can be cooled using a radiator 8 that is a component of a high temperature coolant circuit 9, shown by dotted lines in FIG. 1. A fan 10, assigned to the radiator 8 can guide air through the radiator 8 for the purpose of cooling the cooling medium flowing through the internal combustion engine 1.

With the motor vehicle shown in FIG. 1 in a very schematic block diagram, although the internal combustion engine 1 can be effectively cooled, the required cooling of the power electronics, the electric energy store and/or the electric machine is however difficult.

From the document DE 10 2005 048 241 A1, a two-circuit battery cooling system is known for cooling an electric energy store of a hybrid drive of a motor vehicle. The two circuit battery cooling system disclosed therein has a thermodynamic primary circuit and a thermodynamic secondary circuit, wherein a customary cooling system supplies the thermodynamic primary circuit, and wherein a radiator, which is connected to the evaporator of the customary cooling system, is integrated into both the thermodynamic primary circuit and into the thermodynamic secondary circuit, which serves for cooling the electric energy store of the hybrid drive. With this, it is possible in principle, to cool the electric energy store of a hybrid drive, however using this two circuit battery system known from the prior art, it is not possible to provide needs-based cooling of the power electronics and the electric energy store, and where necessary, the electric machine of the hybrid drive.

### SUMMARY OF THE INVENTION

Proceeding therefrom, the problem addressed by the present invention is to create a novel motor vehicle.

This problem is solved by a motor vehicle according to the invention in which the energy store of the hybrid drive and the power electronics of the hybrid drive are cooled, depending on temperature, via the second radiator, and thus via the first low temperature cooling circuit, or via the cooling system, and thus via the second low-temperature cooling circuit.

The present invention makes possible a completely novel, effective, needs-based cooling of the power electronics, of the electric energy store, and where necessary, the electric machine of the hybrid drive. Depending on the temperature, the electric energy store of the hybrid drive and also the power electronics thereof can be cooled by the second radiator of the first low-temperature cooling circuit or by the cooling system of the second low-temperature cooling circuit. In the process, the electric energy store of the hybrid drive and the power electronics thereof are connected independently of each other to the second low-temperature cooling circuit, upon exceeding different limit temperatures of the cooling means flowing through the second radiator, in order to be cooled by means of the cooling system. As a result, different cooling requirements of the electric energy store and the power electronics can be taken into account, and a needs-based cooling is guaranteed.

### BRIEF DESCRIPTION OF THE DRAWINGS

Preferred further developments of the invention will become apparent from the description that follows. Embodiments of the invention are explained in greater detail with reference to the drawing, without being limited thereto. The figures show:

FIG. 1 an example drive train diagram of a motor vehicle having a hybrid drive according to the prior art;

FIG. 2 a detail of a motor vehicle according to the invention according to a first example embodiment of the invention;

FIG. 3 a detail of a motor vehicle according to the invention according to a second example embodiment of the invention; and

FIG. 4 an alternative for the details of FIGS. 2 and 3.

### DETAILED DESCRIPTION OF THE PREFERRED EMBODIMENTS

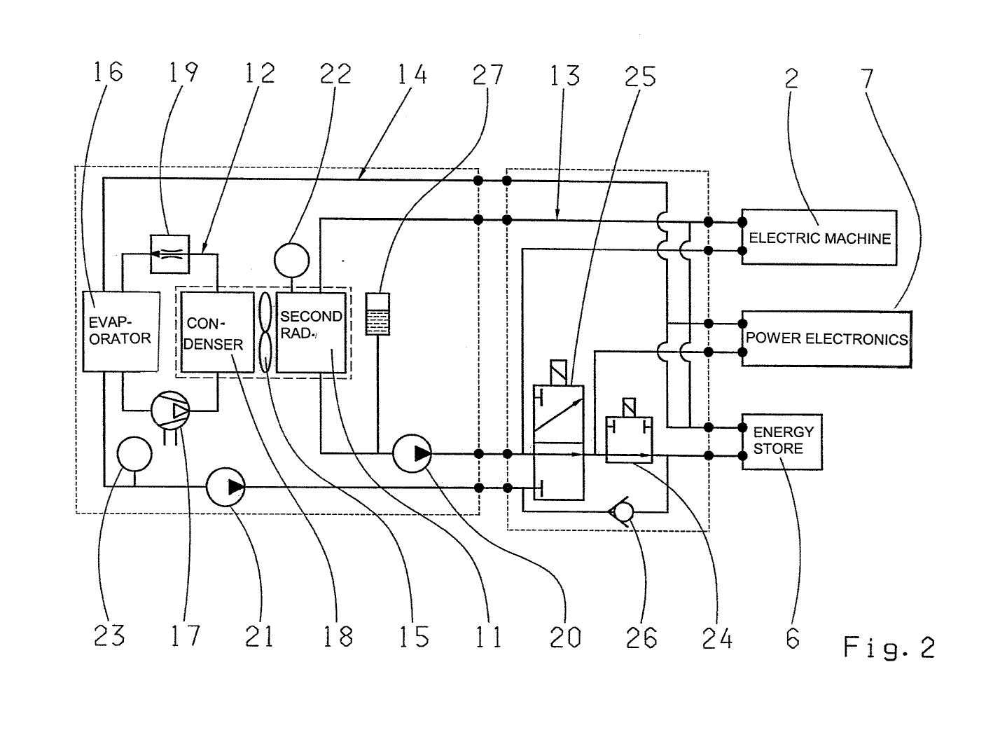

FIG. 2 shows details of a motor vehicle according to the invention according to a first example embodiment of the invention, specifically the details which concern the cooling of the electric energy store 6, the power electronics 7 and where necessary the electric machine 2 of the hybrid drive. The power electronics 7 comprise an inverter to be cooled, not shown in detail, and a voltage converter to be cooled.

The motor vehicle according to the invention comprises, in addition to the first radiator 8 of the high-temperature cooling circuit 9, also a second radiator 11 and an cooling system 12, where the second radiator 11 is assigned to a first low temperature cooling circuit 13 and the cooling system 12 is assigned to the second low temperature cooling circuit 14. The cooling system 14 comprises an evaporator 16, a compressor 17, a condenser 18, and an expansion valve 19. A common fan 15 is assigned to the second radiator 11 and the condenser 18.

A pump 20, and 21, and a temperature sensor 22, and 23, are assigned to the first low temperature cooling circuit 13 and the second low temperature cooling circuit 14, respectively.

By using the pump 20 of the first low-temperature cooling circuit 13, cooling means can be pumped, or conveyed, through the first low-temperature cooling circuit 13, wherein the temperature of the cooling means flowing through the second radiator 11 can be detected using measurement technology of the temperature sensor 22, which is assigned to the second radiator 11 of the first low temperature cooling circuit 13.

The pump 21 of the second low temperature cooling circuit 14 serves for moving cooling means through the second low temperature cooling circuit 14, wherein the temperature of the cooling means leaving the evaporator 16 can be detected using measurement technology of the temperature sensor 23, which is positioned between the evaporator 16 and the pump 21, as viewed in the flow direction of the cooling means flowing through the second low temperature cooling circuit 14.

According to the present invention, the electric energy store 6 of the hybrid drive and also the power electronics 7 of the hybrid drive are cooled, or can be cooled, depending on the temperature, via the second radiator 11 of the first low-temperature cooling circuit 13 or via the cooling system 12 of the second low temperature cooling circuit 14, wherein the electric energy store 6 of the hybrid drive and the power electronics 7 thereof, are connected to the second low temperature cooling circuit 14 for cooling via the cooling system 12 independently of each other, upon exceeding different limit temperatures of the cooling means flowing through the second radiator 11.

Below a first limit temperature of the cooling means flowing through the second radiator 11 of the first low temperature cooling circuit 13, for example, below 25° C. of this cooling means, both the electric energy store 6 of the hybrid drive and also the power electronics 7 thereof are each cooled via the second radiator 11 of the first low temperature cooling circuit 13, for which purpose the pump 20 of the first low temperature cooling circuit 13 runs, the pump 21 of the second low temperature cooling circuit 14 is stopped, and the two temperature-dependent controlled valves 24 and 25 shown in FIG. 2 take on the positions of switch setting shown in FIG. 2. The valve 24 is a 2/2 way control valve, and the valve 25 is a 3/2 way control valve.

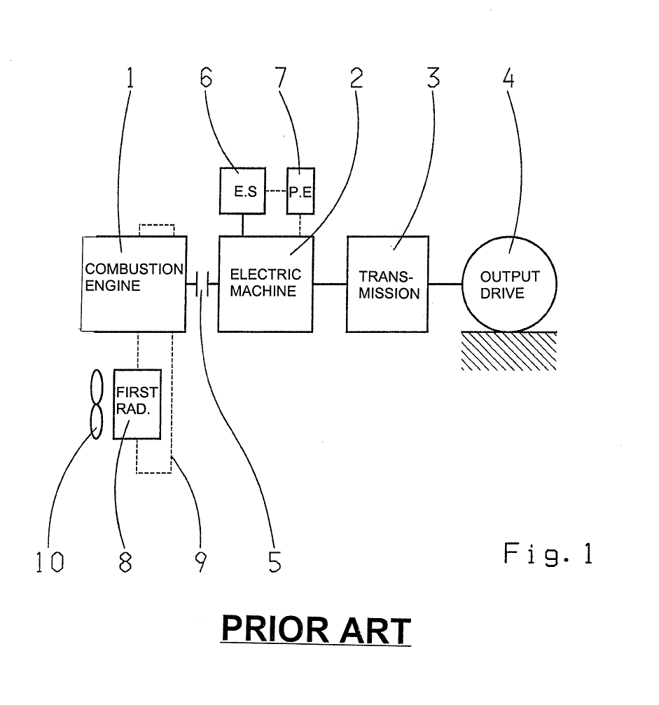

When the temperature of the cooling means flowing through the second radiator 11 of the first low temperature cooling circuit 13 exceeds the first limit temperature, and is less than a second limit temperature, for example less than 50° C., the electric energy store 6 of the hybrid drive is cooled via the cooling system 12 of the second low temperature cooling circuit 14, whereas the power electronics 7 are still cooled via the second radiator 11 of the first low temperature cooling circuit 13. For this purpose then, depending on the temperature of the cooling means flowing through the second radiator 11 of the first low temperature cooling circuit 13, which is detected by the sensor 22, a control device, not shown, switches on the pump 21 of the second low temperature cooling circuit 14, and sets the valve 24 into the second switch setting thereof, such that the electric energy store 6 of the hybrid drive is then decoupled from the first low temperature cooling circuit 13 and coupled to the second low temperature cooling circuit 14. The valve 25 remains in the switch setting thereof, shown in FIG. 1, such that the power electronics 7 remain coupled to the first low temperature cooling circuit 13.

When the temperature of the cooling means flowing through the second radiator 11 of the first low temperature cooling circuit 13 also exceeds the second limit temperature, both the electric energy store 6 and the power electronics 7 are connected to the second low temperature cooling circuit 14, such that then both the electric energy store 6 and the power electronics 7 are cooled by the cooling system 12 of the second low temperature cooling circuit 14. For this purpose, the control device, not shown, sets the temperature dependent controlled valve 25 also into the second switch setting thereof, such that then the power electronics 7 are also decoupled from the first low temperature cooling circuit 13 and coupled to the second low temperature cooling circuit 14.

The two valves 24 and 25 and the pumps 20 and 21 are controlled, as already explained, using the control device, not shown, which is supplied, as an input variable, at least the temperature of cooling means flowing through the second radiator 11 of the of the first low temperature cooling circuit 13 that is measured using the temperature sensor 22. Depending on this temperature, the control device, not shown, connects the electric energy store 6 and the power electronics 7 for cooling thereof to the second low temperature cooling circuit 14, specifically in succession, where the energy store 6 is connected to the second low temperature cooling circuit 14 first upon exceeding a first limit temperature, and the power electronics 7 subsequently upon exceeding a second, higher limit temperature. As seen in FIG. 2, the electric machine 2 of the hybrid drive is permanently cooled by the second radiator 11 of the first low temperature cooling circuit 13.

When the energy store 6 and if applicable the power electronics 7 of the hybrid drive are connected to the second low temperature cooling circuit 14 for cooling thereof by cooling system 12, the temperature of the cooling means of the second low temperature cooling circuit 14, detected by the temperature sensor 23, can be used by the control device, not shown, to regulate the power of the cooling system 12.

When the two valves 24 and 25 are in the switch setting shown in FIG. 2, the non-return valve 26, shown in FIG. 2, prevents cooling means from the first low temperature cooling circuit 13 from being able to enter the second low temperature cooling circuit 14. As already mentioned, the valves 24 and 25 are in the position shown in FIG. 2, only when the temperature of the cooling means of the first low temperature cooling circuit 13 flowing through the second radiator 11 is less than the first limit temperature, where in this case, the pump 21 is switched off.

As already explained, depending on the switch position which the valves 24 and 25 are set to, the electric energy store 6 and the power electronics 7 are either connected to the first low temperature cooling circuit 13 or to the second low temperature cooling circuit 14. A reservoir 27 in the first low temperature cooling circuit 13 serves for supplying additional cooling means or for receiving excess cooling means, depending on the switch settings of the valves 24 and 25. The second low temperature cooling circuit 14 can likewise be assigned such a reservoir. Alternatively, it is possible to receive excess cooling means as well as to provide additional cooling means via an appropriate reservoir of the high temperature cooling circuit.

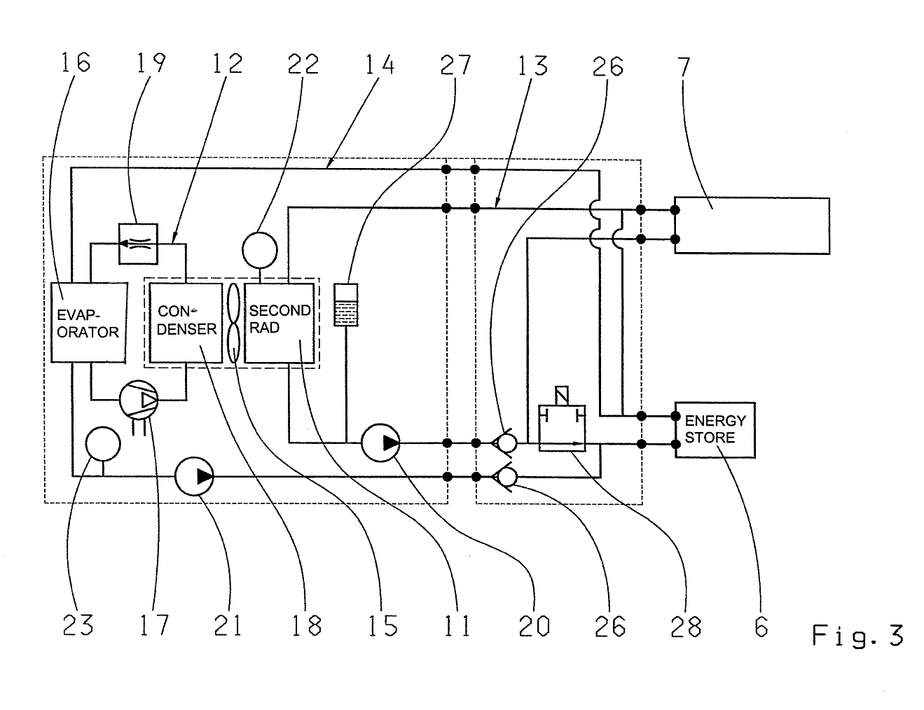

FIG. 3 shows a simplified variant of the invention in which the electric machine 2 of the hybrid drive is cooled neither by the first low temperature cooling circuit 13 nor by the second low temperature cooling circuit 14, but rather by the high temperature cooling circuit 9, by means of which the internal combustion engine 1 of the hybrid drive is also cooled.

In this case, there is a single temperature dependent controlled valve 28 which is in the position shown in FIG. 3 when the temperature of the cooling means flowing through the first low temperature cooling circuit 13, or the second radiator 11 of the same, is less than the first limit temperature, wherein then the pump 20 of the first low temperature cooling circuit 13 is switched on, and the pump 21 of the second low temperature cooling circuit 14 is switched on. In this case then, the electric energy store 6 and the power electronics 7 are both cooled by the second radiator 11, and thus, by the first low temperature cooling circuit 13.

When the temperature of the cooling means flowing through the second radiator 11 exceeds the first limit temperature, but is however, less than the second limit temperature, then the valve 28 is set to the second switch setting wherein then the pump 21 of the second low temperature cooling circuit 14 is switched on. In this case, the electric energy store 6 is then decoupled from the first low temperature cooling circuit 13 and coupled to the second low temperature cooling circuit 14, in order to be cooled by the cooling system 12. The power electronics 7 continue to be cooled by the second radiator 11, and thus by the first low temperature cooling circuit 13.

When the temperature of the cooling means flowing through the second radiator 11 is greater than the second limit temperature, both pumps 20, 21 remain switched on, and the valve 28 again takes on the switch setting shown in FIG. 3, wherein then both the electrical energy store 6 and the power electronics 7 are cooled by both the radiator 11 and by the cooling system 12.

Common to all example embodiments of FIG. 2 and FIG. 3, is that when the temperature of the cooling means of the first low temperature cooling circuit 13, which flows through the second radiator 11, is less than the first limit temperature, both the electric energy store 6 and the power electronics 7 are cooled by the first low temperature cooling circuit 13, and thus, by the second radiator 11. When the temperature of the cooling means flowing through the second radiator 11, is greater than the first limit temperature but less than the second limit temperature, then only the electric energy store 6 is connected to the second low temperature cooling circuit 14, such that the electric energy store is cooled by the cooling system 12, whereas the power electronics 7 are still cooled by the second radiator 11.

When the temperature of the cooling means flowing through the second radiator 11 exceeds also the second limit temperature, then subsequently also the power electronics 7 are connected to the second low temperature cooling circuit 14, so that then both the electric energy store 6 and the power electronics 7 are cooled by the cooling system 12, and thus, by the second low temperature cooling circuit 14.

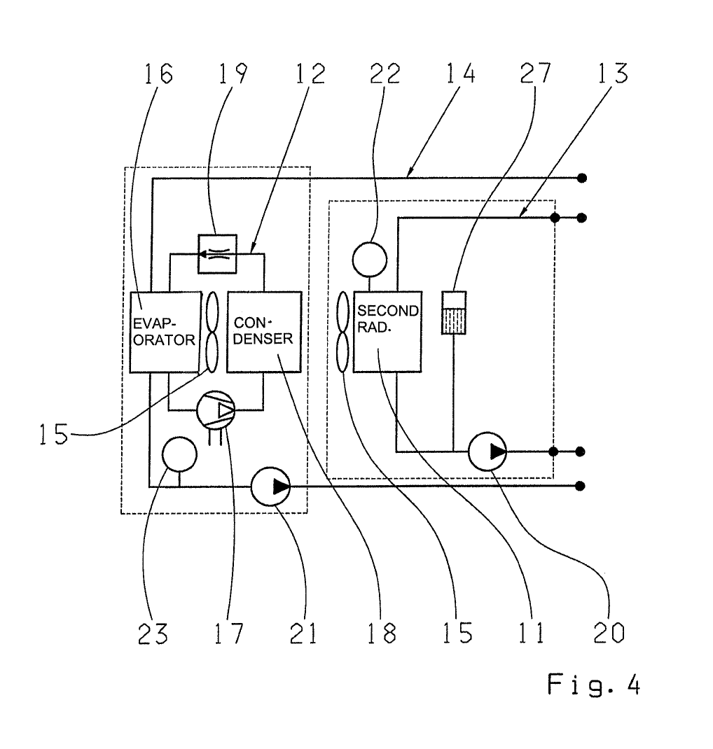

FIG. 4 shows a variant to the example embodiments of FIG. 2 and FIG. 3 in which the radiator 11 of the first low temperature cooling circuit 13 and the condenser 18 of the cooling system 12 of the second low temperature cooling circuit 14 are assigned separate, individual fans 15.

According to an advantageous further development of the present invention, it is possible that temperature sensors, which supply measurement values of the temperature of the cooling means flowing through the same to the control device, not shown, are also assigned to the assemblies of the hybrid drive to be cooled via the low temperature cooling circuits 13 and 14, thus to the electric energy store 6 and/or the power electronics 7 and of applicable the electric machine 2. Thereby, it is possible that, based on the temperatures, provided by the sensors 22, 23 of the low temperature cooling circuits 13, 14 and the temperature sensors assigned to the assemblies 6, 7, 2 of the hybrid drive, the control device determines whether one of the pumps 20 or 21 of the two low temperature cooling circuits 13 or 14 is defective.

Thus, it is possible for example in the example embodiment of FIG. 2, with an activated pump 20 of the first low temperature cooling circuit 13, that the control device checks to compare the temperature of the cooling means flowing through the radiator 11 detected by the temperature sensor 22 with the temperature of the electric machine 2, which is to be cooled by the first low temperature cooling circuit 13.

If as a result, it is determined that there is a significant deviation between these temperatures, then it can be concluded that the cooling means pump 20 of the first low temperature cooling circuit 13 is defective. In this case then, the cooling means pump 21 of the second low temperature cooling circuit 14 can be activated by the control device in order to provide redundancy in the cooling.

The functionality of the pump 21 of the second low-temperature cooling circuit 14 can be checked similarly, where then for example, with an activated pump 21, the temperature measured by the temperature sensor 23 can be compared to a temperature detected by the temperature sensor assigned to the electric energy store 6.

In the example embodiment of FIG. 3, the failure of a pump 20 or 21 can be detected similarly in order to provide redundancy of the cooling function.

### REFERENCE CHARACTERS

1 internal combustion engine
2 electric motor
3 transmission
4 output drive
5 clutch
6 energy store
7 power electronics
8 first radiator
9 high temperature cooling circuit
10 fan
11 second radiator
12 cooling system
13 first low temperature cooling circuit
14 second low temperature cooling circuit
15 fan
16 evaporator
17 compressor
18 condenser
19 expansion valve
20 pump
21 pump
22 temperature sensor
23 temperature sensor
24 valve
25 valve
26 non-return valve
27 reservoir
28 valve

1-12. (canceled)

13. A motor vehicle having a hybrid drive, a transmission connected between the hybrid drive and an output drive, the hybrid drive comprising:
an internal combustion engine (1),
an electric machine (2),
an electric energy store (6), and
power electronics (7), with a high temperature cooling circuit (9) comprising a first radiator (8) by which the internal combustion engine (1) of the hybrid drive is cooled, with a first low temperature cooling circuit (13) comprising a second radiator (11) and a second low temperature cooling circuit (14) comprising a cooling system (12),
wherein both the energy store (6) of the hybrid drive and the power electronics (7) of the hybrid drive are cooled depending on temperature by the second radiator (11), and thus by the first low temperature cooling circuit (13), or by the cooling system (12), and thus by the second low temperature cooling circuit (14).

14. The motor vehicle according to claim 13, wherein the energy store (6) of the hybrid drive and the power electronics (7) of the hybrid drive, upon exceeding different limit temperatures of the cooling means flowing through the second radiator (11), are connected independently of each other for the cooling thereof via the cooling system (12) of the second low temperature cooling circuit (14).

15. The motor vehicle according to claim 13, wherein below a first limit temperature of the cooling means flowing through the second radiator (11), both the energy store (6) of the hybrid drive and also the power electronics (7) of the hybrid drive are each cooled by the second radiator (11), and thus by the first low temperature cooling circuit (13).

16. The motor vehicle according to claim 15, wherein above the first limit temperature, but below a second limit temperature of the cooling means flowing through the second radiator (11), the energy store (6) of the hybrid drive is cooled by the cooling system (12), and thus by the second low temperature cooling circuit (14), whereas the power electronics (7) of the hybrid drive are cooled by the second radiator (11), and thus by the first low temperature cooling circuit (13).

17. The motor vehicle according to claim 16, wherein above the second limit temperature of the cooling means flowing through the second radiator (11), both the energy store (6) of the hybrid drive and the power electronics (7) of the hybrid drive are cooled by the cooling system (12), and thus by the second low temperature cooling circuit (14).

18. The motor vehicle according to claim 13, wherein the electric machine (2) of the hybrid drive is cooled by the second radiator (11) of the first low temperature cooling circuit (13).

19. The motor vehicle according to claim 18, wherein at least two valves (24, 25) are controlled, on a basis of temperature, such that when a first limit temperature of the cooling means flowing through the second radiator (11) is exceeded, a control device switches a first temperature-dependent controlled value (24) such that the energy store (6) is decoupled from the first low temperature cooling circuit (13), and coupled to the second low temperature cooling circuit (14), and when a second limit temperature of the cooling means flowing through the second radiator (11) is exceeded, the control device additionally switches a second temperature dependent controlled valve (25) such that additionally the power electronics (7) are decoupled from the first low temperature cooling circuit (13) and coupled to the second low temperature cooling circuit (14).

20. The motor vehicle according to claim 19, wherein when the first limit temperature of the cooling means flowing through the second radiator (11) is exceeded, the control device switches to a temperature dependent controlled pump (21) of the second low temperature cooling circuit (14).

21. The motor vehicle according to claim 13, wherein the electric motor (2) is cooled by the first radiator (8) of the high temperature cooling circuit (9).

22. The motor vehicle according to claim 21, wherein at least one temperature dependent controlled valve (28), when the first limit temperature of the cooling means flowing through the second radiator (11) is exceeded, a control device switches the temperature dependent controlled valve (28) such that the energy store (6) is decoupled from the first low temperature cooling circuit (13) and coupled to the second low temperature cooling circuit (14), and when a second limit temperature of the cooling means flowing through the second radiator (11) is exceeded, the control device switches the temperature dependent controlled valve (28) such that the energy store (6) and the power electronics (7) are both coupled to the second low temperature cooling circuit (14).

23. The motor vehicle according to claim 13, wherein a first temperature sensor (22) and a first pump (20) are assigned to the first low temperature cooling circuit (13), a second temperature sensor (23) and a second pump (21) are assigned to the second low temperature cooling circuit (14), and a further temperature sensor is assigned to at least one of the energy store (6), the power electronics (7) and the electric machine (2).

24. The motor vehicle according to claim 23, wherein a control device, depending on a comparison of temperatures supplied to the control device by the respective first and the second temperature sensor (22, 23) of the particular first and the second low temperature cooling circuit (13, 14) and by the further temperature sensor of an assembly (6, 7, 2) of the hybrid drive cooled by the particular first and the second low temperature cooling circuit (13, 14), determines for at least one of the first low temperature cooling circuit (13) and the second low temperature cooling circuit (14) whether the respective first and the second pump (20, 21) of the respective first and the second low temperature cooling circuit (13, 14) is one of operating or failed.
